(19) United States
(12) Patent Application Publication
(10) Pub. No.: US 2024/0184836 A1
(43) Pub. Date: Jun. 6, 2024

(54) PERSONALIZED RETRIEVAL

(71) Applicant: Microsoft Technology Licensing, LLC, Redmond, WA (US)

(72) Inventors: Shivam MITTAL, New Dehli (IN); Sheshansh AGRAWAL, Bellevue, WA (US); Hemanth VEMURI, Hyderabad (IN); Deepak SAINI, Bellevue, WA (US); Akshay SONI, Santa Clara, CA (US); Abhinav VISWANATHAN SAMBASIVAN, Milpitas, CA (US); Yajun WANG, Sunnyvale, CA (US); Mehulkumar PARSANA, Bellevue, WA (US); Wenhao LU, Seattle, WA (US); Manik VARMA, South Moti Bagh (IN)

(21) Appl. No.: 17/970,104

(22) Filed: Oct. 20, 2022

(51) Int. Cl. G06F 16/9535; G06F 16/242

(52) U.S. Cl. CPC G06F 16/9535; G06F 16/242

(57) ABSTRACT

The present disclosure relates to systems and methods for providing personalized retrievals of items. The systems and methods create a user-specific morph operator for a user that captures learned user preferences for the user. The systems and methods use the user-specific morph operator to transform a generic embedding for a query into a personalized embedding for the query. The systems and method use the personalized embedding to retrieve items based on the user preferences to present in response to the query.

### BACKGROUND

Recommendation systems are systems which help users to find items relevant to them from a large corpus of items. The items may be any content such as, music, videos, products, restaurants, news articles, webpages, advertisements, etc. The entities that a system recommends are known as items and the information that is used to make those recommendations is called query/queries. The query can contain information from the user's past activity (e.g., the past interactions with items, previous search queries, etc.), and/or user profile information (location, age, gender, etc.).

Recommendation systems are classically split into two stages (retrieval and ranking). The retrieval stage is responsible for generating a few candidate items (about hundreds or thousands) from a large corpus of items (which can range from millions to billions), and a ranking layer scores and ranks the retrieved candidates which is finally shown to the user. Since retrieval operates over a large corpus of items, it is common to perform non-personalized and inexpensive retrieval and perform personalizing ranking afterwards. Despite being scalable, this strategy risks losing items uniquely relevant to a user's preferences that fail to get shortlisted during non-personalized retrieval.

A common method to do retrieval is dense retrieval where items and queries are embedded in a geometric space such that relevant items are near to each other. For a given query, efficient nearest neighbor search or Maximum Inner Product Search (MIPS) using Approximate Nearest Neighbor Search (ANNS) can be used to find relevant items for that query.

When an individual event from the user's activity is used as a query for retrieval, it is per-event retrieval. Per-event retrieval takes a user event and retrieves items most relevant to that event from a large catalog of candidate items. Per-event retrieval is a popular paradigm in ranking and recommendation systems and several tasks (e.g., product-to-product recommendations and search) are per-event retrieval tasks. In tasks such as homepage recommendations that retrieve items to cater to multiple interests of the user depending upon the user's past activity, per-event retrieval is performed for each event in the user's past activity and the set of retrieved ads from all the events is returned. When per-event retrieval is non-personalized, it is non-personalized per-event retrieval (NPPR). In non-personalized per-event retrieval, two different individuals performing the same event, the same recommendations or search results are retrieved for them.

When retrieving from multiple events from the user's past activity to capture multiple interests/intents of the user, it becomes expensive to do per-event retrieval from all events in the user's past activity as the number of events might be very large. Although, there are multiple events that correspond to the same interest/intent of the user. So, there is another class of methods that captures these interests from the user's past activity using multi-user representations, where each representation captures an intent/interest of a user. These interest/intent representations are used as queries for retrieval, which are generally much lesser in number than the total events, and hence much cheaper. But these class of methods do not offer sufficient personalization as well, since each interest/intent representation does not capture information about user's tastes or preferences from the user's activity from different interests and/or the user profile.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Some implementations relate to a method. The method includes creating a generic embedding for a query. The method includes applying a user-specific morph operator to the generic embedding, wherein the user-specific morph operator identifies user preferences for a user. The method includes creating a personalized embedding for the query by applying the user-specific morph operator to the generic embedding.

Some implementations relate to a device. The device includes a processor; memory in electronic communication with the processor; and instructions stored in the memory, the instructions being executable by the processor to: create a generic embedding for a query; apply a user-specific morph operator to the generic embedding, wherein the user-specific morph operator identifies user preferences for a user; and create a personalized embedding for the query by applying the user-specific morph operator to the generic embedding.

Some implementations relate to a method. The method includes accessing a user history of previous actions performed by a user. The method includes using a machine learning model to learn user preferences for the user based on analyzing the user history or user profile information. The method includes creating a user-specific morph operator for the user based on the user preferences.

Some implementations relate to a device. The device includes a processor; memory in electronic communication with the processor; and instructions stored in the memory, the instructions being executable by the processor to: access a user history of previous actions performed by a user; use a machine learning model to learn user preferences for the user based on analyzing the user history or user profile information; and create a user-specific morph operator for the user based on the user preferences.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail using the accompanying drawings in which:

FIG. 1 illustrates an example environment for personalized retrievals in accordance with implementations of the present disclosure.

FIG. 2 illustrates an example morph operator creation component and recommendation system for use with personalized retrievals in accordance with implementations of the present disclosure.

FIG. 3 illustrates an example of personalized retrieval for an event in accordance with implementations of the present disclosure.

FIG. 4 illustrates an example method for personalized retrievals in accordance with implementations of the present disclosure.

FIG. 5 illustrates an example method for creating a user-specific morph operator in accordance with implementations of the present disclosure.

FIG. 6 illustrates components that may be included within a computer system.

### DETAILED DESCRIPTION

This disclosure generally relates to personalized retrieval. Personalization may relate to intents and/or interests of a user, and thus, the retrieval is personalized based on the intents and/or interests of the user. In addition, personalization may relate to events, and thus, the retrieval is personalized per-event (personalized per-event retrieval).

Recommendation systems are systems which help users to find items relevant to them from a large corpus of items. The items may be any content such as, music, videos, products, restaurants, news articles, webpages, advertisements, etc. The entities that a system recommends are known as items and the information that is used to make those recommendations is called query/queries. The query can contain information from the user's past activity (e.g., the past interactions with items, previous search queries performed, etc.), and/or user profile information (location, age, gender, etc.).

Recommendation systems are classically split into two stages (retrieval and ranking). The retrieval stage is responsible for generating a few candidate items (about hundreds or thousands) from a large corpus of items (which can range from millions to billions), and a ranking layer scores and ranks the retrieved candidates which is finally shown to the user. Since retrieval operates over a large corpus of items, it is common to perform non-personalized and inexpensive retrieval and perform personalizing ranking afterwards. Despite being scalable, this strategy risks losing items uniquely relevant to a user's preferences that fail to get shortlisted during non-personalized retrieval.

A common method to do retrieval is dense retrieval where items and queries are embedded in a geometric space such that relevant items are near to each other. For a given query, efficient nearest neighbor search or Maximum Inner Product Search (MIPS) using Approximate Nearest Neighbor Search (ANNS) may be used to find relevant items for that query.

When an individual event from the user's activity is used as a query for retrieval, it is per-event retrieval. Per-event retrieval takes a user event and retrieves items most relevant to that event from a large catalog of candidate items (e.g., millions to billions of items). Per-event retrieval is a popular paradigm in ranking and recommendation systems and several tasks, such as, product-to-product recommendations, search, and advertisement retrievals are per-event retrieval tasks. In tasks such as homepage recommendations that retrieve items to cater to multiple interests of the user depending upon the user's past activity, per-event retrieval is performed for each event in the user's past activity and the set of retrieved advertisements from all the events is returned. When such retrieval is non-personalized, it is non-personalized per-event retrieval (NPPR). In non-personalized per-event retrieval, two different individuals performing the same event, the same recommendations or search results are retrieved for the individuals. For example, if two users (a man and a woman) visit the same webpage to purchase perfume, non-personalized per event retrieval recommends the same advertisements to both users.

When retrieving from multiple events from the user's past activity to capture multiple interests/intents of the user, it becomes expensive to do per-event retrieval from all events in the user's past activity as the number of events might be very large. Although, there are multiple events that correspond to the same interest/intent of the user. So, there is another class of methods that captures these interests from the user's past activity using multi-user representations, where each representation captures an intent/interest of a user. These interest/intent representations are used as queries for retrieval, which are generally much lesser in number than the total events, and hence much cheaper. But these classes of methods do not offer sufficient personalization as well since each interest/intent representation does not capture information about user's tastes or preferences from the user's activity from different interests and/or the user profile.

Consider a user (u), a query (q) (q may be an event performed by the user or an interest/intent of the user inferred from multiple event interactions by the user) and let (a) be a relevant candidate item to this query (q). Dense NPPR techniques learn a deep architecture ϕ to embed user query and candidate items into a shared vector space so that the dot product [symbol] ϕ(q),ϕ(a) [symbol] is indicative of the relevance of the query (q) to candidate item (a). Note that the embedding function ϕ does not depend on the user (u) (the embedding function is non-personalized). The items most relevant to a query (q) can be retrieved simply by running a Maximum Inner Product Search (MIPS) query with the test query embedding ϕ(qₜ).

One possibility to perform personalized retrieval is to use non-decomposable personalized scoring functions of the form f(a, q, u) indicating the relevance of a candidate item (a) for a query (q) performed by user (u). The score is personalized as it depends on the user (u) (e.g., the user's browsing history). Existing methods use nonlinear architectures that offer effective personalization but also preclude the MIPS trick and require applying functions explicitly to each candidate item to find the most relevant ones incurring infeasible inference times when candidate items are in the millions. Personalization is rarely attempted over catalogs of millions of items since the cost of existing personalization routines scale linearly in the number of candidate items. As such, existing methods incur infeasible inference times when candidate items are in the millions, or existing methods require enormous compute and storage requirements.

One current workaround is to shrink the candidate set by first performing non-personalized retrieval and then applying personalized ranking only to the shortlisted items. However, items that fail to get shortlisted by the non-personalized retrieval step are irrevocably lost even if personalization could have later found them to be relevant to a particular user's tastes. Scalable personal retrieval over millions of items poses opportunities and computational challenges.

It is challenging to accelerate personalized retrieval using MIPS. One possibility to perform personalized retrieval is two-sided personalization by learning two personalized embedding functions that is unique to every user. One personalized embedding function ϕₐ_{ᵤ} may be used to personalize the corpus of candidate items and the other embedding function ϕ_{q}_{ᵤ} may be used to personalize user query and [symbol] ϕ_{q}_{ᵤ}(q), ϕₐ_{ᵤ}(a) [symbol] may be used as the relevance score. Two-sided personalization can offer more flexible and accurate retrieval and can offer accelerated retrieval if a separate MIPS structure over the entire candidate set is established separately for every user. For a million items and a billion users, creating these structures alone would require a million multiplied by a billion compute and storage, which would make this approach infeasible.

The systems and methods of the present disclosure focus on personalizing the retrieval stage in a computationally and resource efficient manner. The systems and methods of the present disclosure adapt to long-term preferences of a user and take into account immediate or short-term preferences of the user in performing personalized retrievals. Long-term preferences may include preferences based on demographic profiles of the user (e.g., age and gender) or other preferences of the user (e.g., brand, price, color preferences, music taste, etc.).

The systems and methods adapt to the long-term preferences of the user by learning different morph operators for each user. Morph operators are functions that takes in a generic query embedding (or a non-personalized query embeddings) as an input and produces a personalized query embedding. The morph operators encode user preferences, which morph the generic embedding toward an embedding that is personalized for a user. One example of a user-specific morph operator includes matrix multiplication. Another example of a user-specific morph operator includes machine learning models such as a neural network. Each user has a user-specific morph operator that identifies the user preferences of the user. The user-specific morph operators transform a generic embedding for a query to a personalized embedding for the query that retains the information for the query and incorporates the user's long-term preferences. The personalized embedding is used to query a maximum inner product search (MIPS) structure that provides retrievals for the query personalized to the user's tastes and preferences. As such, the systems and methods provide personalized retrieval that personalizes the items presented to the user in response to event(s) being performed by the user and the user's preferences or habits of the user.

One example use case of the systems and methods include if two users (a man and a woman) visit the same webpage to purchase perfume, the systems and methods use the user-specific morph operators to capture the information about each user's preferences (e.g., gender preferences or other user preferences learned from the browsing history of each user) and morph the event embedding of the perfume page to reflect the personal preferences of the users so that the personalized event embedding of the man lies close to male perfume products and that of the woman to female perfume products. As such, the two users receive distinct recommendations (e.g., the man receives recommendations relating to male perfume products and the woman receives recommendations relating to female perfume products).

Another example use case of the systems and methods include if a user visits a car webpage to view a new car, the systems and methods use the user-specific morph operators to capture the information about the user's preferences for cars. If the user had previously looked at used cars or clicked on advertisements for car sales, the user-specific morph operator indicates the user's preferences for used cars or discounted cars. The systems and methods generate a personalized event embedding for visiting the car webpage that reflects the user's preferences for used cars or discounted cars. The personalized event embedding is used to retrieve advertisements related to used cars or discounted cars to present to the user. As such, targeted advertisements are presented that are tailored to the user's preferences. In contrast, if a current non-personalized retrieval system was used for the car webpage, the advertisements may only relate to the make or model of the car being viewed without taking into consideration the user's preferences for used cars or discounted cars.

In some implementations, the user-specific morph operator is a matrix multiplication operator. Two-sided personalization is performed by learning two matrices. One matrix (Pᵤ) is used to personalize the corpus of candidate items (ϕₐ_{ᵤ}(a)=Pᵤ^{T}a) and the other matrix (Qᵤ) is used to personalize user query (ϕqᵤ(q)=Qᵤ^{T}q) and [symbol] ϕ_{q}_{ᵤ}(a), ϕₐ_{ᵤ}(a) [symbol] may be used as the relevance score. [symbol] ϕ_{q}_{ᵤ}(q), ϕₐ_{ᵤ}(a) [symbol] =(Qᵤ^{T}q)^{T}Pᵤ^{T}a=q^{T}QᵤPᵤ^{T}a. The two matrices are learned at the time of learning the user-specific morph operators. During inference, a separate MIPS structure over the entire candidate set is required separately for every user to provide accelerate retrieval, which may incur high storage cost making this approach undesirable. Instead, the methods and systems use a matrix L such that Lᵤ=QᵤPᵤ^{T} to personalize just the query side. The matrix L is used to personalize the query for each user while keeping the corpus of candidate items non personalize. The relevance score is [symbol] ϕᵤ(q),a [symbol] =(Lᵤ^{T}q)^{T}a=q^{T}Lᵤa=q^{T}QᵤPᵤ^{T}a, which is equal to the two-sided relevance score [symbol] ϕ_{q}_{ᵤ}(q), ϕₐ_{ᵤ}(a) [symbol] . Hence, to the methods and systems are able to personalize both the user event and the items retrieved according to the user because of the matrix decomposition. By using this user-specific morph operator, the systems and methods provide two-sided personalization, but the cost is the same as one side personalization (e.g., personalizing just the query side). The systems and methods use a single MIPS structure of items, and thus, reducing the storage cost and achieving low storage overheads. The MIPS structure is a single approximate nearest neighbor (ANN) search structure over the candidate items.

In some implementations, the user-specific morph operator is a complex machine learning model, such as a neural network. In some implementations, the user-specific morph operator is applied to events. In some implementations, the user-specific morph operator is applied to intents/interests/channels of the user to personalize the interests/intents/channels of the user. In some implementations, the user-specific morph operator is applied to personalize different representations for the users. As such, the user-specific morph operators may be used to transform a variety of events, intents/interests/channels, and/or users' representations to personalized events, intents/interests/channels, and/or user representations.

The systems and methods provide personalization in the retrieval of items by adapting to long term preferences of the user without requiring frequent updates to the system architectures or incurring any significant compute or storage costs. The systems and methods of the present provides two-sided personalization over millions of items and billions of users by using the user-specific morph operators that offer multi-intent retrieval and may be used with arbitrary encoder architectures. As such, the systems and methods avoid the memory overheads of two-sided personalization and offers personalized retrievals on catalogs of millions of items with millisecond-scale inference time.

One technical advantage of the systems and methods of the present disclosure is low storage overheads. For example, the systems and methods reduce compute and storage cost to O(million+billion) instead of O(million*billion), as would incur if separate MIPS structure are used for each user instead of the systems and methods of the present disclosure. Another technical advantage of the systems and methods of the present disclosure is high computational efficiency. In some implementations, given a user event, the systems and methods provide personalized recommendations to the user within milliseconds. For example, the systems and methods reduce inference time to O(log(billion)) instead of O(billion) that would occur if a personalized scoring were to be used by traditional personalized ranking techniques.

Another technical advantage of the systems and method of the present disclosure is providing two-sided personalization with low storage overheads and reducing the inference time for the personalized retrievals. The methods and systems provide personalized per event retrieval on catalogs of millions of potential items within millisecond-scale inference time. Another technical advantage is the systems and methods of the present disclosure work with arbitrary encoder architectures making it very easy to implement, without making significant changes to existing systems. As such, the systems and methods of the present disclosure provide personalization using the user-specific morph operators.

In some implementations, the systems and methods provide personalization using the user-specific morph operators to personalize intents/interests of a user. In some implementations, clustering is used to get intent/interest representation of users from the representation of events performed by the user. These user event representations for each user are categorized/partitioned into clusters (also known as channels) using clustering algorithms, such as, k-means algorithm, ward algorithm, etc., resulting in similar events performed by the user, to be clustered together. Each cluster/channel contains similar events performed by the user, and each cluster/channel may be regarded as one interest/intent of the user. The different clusters/channels represent different interest/intents of the user. A single representation may be chosen from each cluster/channel to act as the intent/interest representation. In some implementations, the cluster/channel representation is the recent-most events performed by the user in that cluster/channel. In some implementations, the cluster/channel representation is the mean or medoid of all events performed by the user in that channel. In some implementations, machine learning models are used to obtain a single representation from the events in the channel. In some implementations, other multi-channel structures (e.g., memory networks, etc.) are used to obtain intent/interest representations for users.

In some implementations, the systems and methods provide personalized events using the user-specific morph operators resulting in personalized per-event retrievals. This allows the retrieved set of items to be tailored to the user's long-term preferences (captured by the user history) and immediate or short-term preferences of the user so that two users with distinct preferences receive distinct retrievals with item recommendations even if the two users perform the same event. For example, if the two users visit the same webpage, the two users receive different item recommendations based on the user's preferences in response to visiting the same webpage. Another example includes if the two users ask the same search query, the two users receive distinct item recommendations based on the user's preferences in response to the search query.

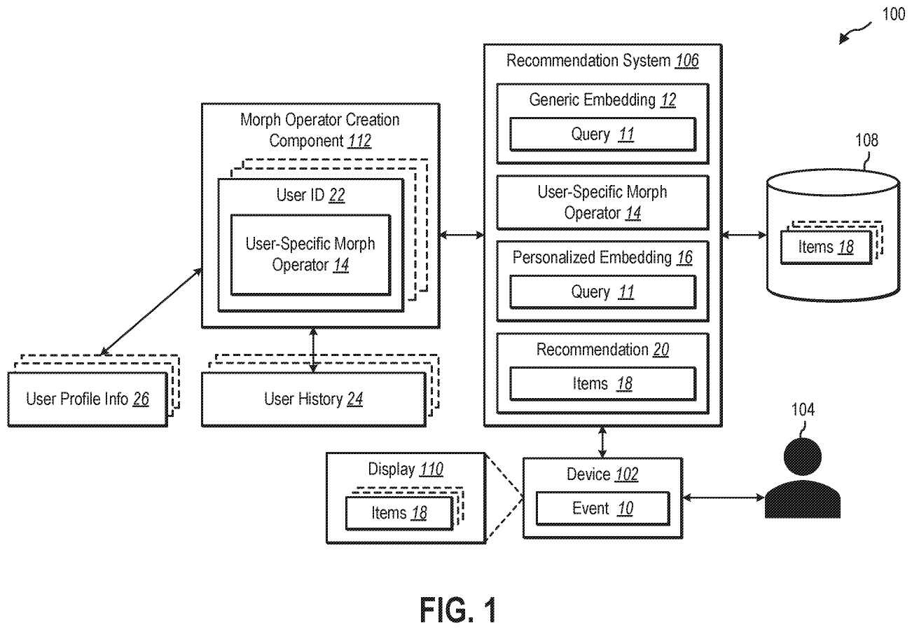

Referring now to FIG. 1, illustrated is an example environment 100 for personal retrievals. The environment 100 includes a device 102 that a user 104 uses to perform an event 10. Events 10 include user activities that the user 104 performs using the device 102. Example events 10 include browsing history, visiting webpages, clicking on an advertisement, performing searches, using a web browser to ask queries, shopping online, purchasing products online, and/or reviewing products. For example, the user 104 uses a browser on the device 102 to perform a search for birthday presents. The information from the user activities is used to identify the event 10 and the user 104.

The device 102 is in communication with a recommendation system 106 that provides one or more items 18 in response to the event 10 occurring on the device 102 or the event 10 occurring on any device by the user 104. The items 18 may be relevant to the event 10 and includes any content, such as, music, videos, products, restaurants, news articles, webpages, advertisements, etc. In addition, the items 18 may be relevant to the interests/intents/channels of the user 104 based on the user's 104 past activities (e.g., past events performed by the user 104), i.e., user history 24 and the latest event 10. The items 18 are presented on a display 110 of the device 102 or any other device that the user 104 is using to perform the event 10. In some implementations, the items 18 are automatically presented on a webpage in response to the user 104 accessing the webpage. In some implementations, the items 18 are presented in response to an event 10 (e.g., an action or task) performed by the user 104 (e.g., performing a search or online shopping). The items 18 include any recommendations based on the event 10 performed by the user 104 and/or the past user history 24. For example, the items 18 include advertisements. Another example for the items 18 includes products to recommend. Another example for the items 18 includes other content (videos, text, audio).

One example use case includes the user 104 performing the event 10 of visiting a search engine and performing a query on the search engine and the items 18 presented on the webpage include any recommendations based on the query entered on the search engine. Another example use case includes the user 104 performing the event 10 of visiting a homepage and the items 18 presented on the homepage include recommendations based on the user's 104 interests inferred by user history 24. For example, a shopping store homepage shows the products a user might like based on the user history 24, a new homepage shows the news articles that the user may be interested in based on the user history 24. Another example use case includes the user 104 is using a webpage to shop online and is viewing a particular product and the items 18 presented on the webpage include recommended products that are similar to the products that the user is viewing on the webpage. Another example use case includes the user 104 browsing a website and the items 18 presented on the webpage include advertisements related to the content on the website and/or the user history 24. As such, the items 18 presented may be in response to the event 10 performed by the user 104 and/or the past events of the user history 24.

In some implementations, the recommendation system 106 is remote from the device 102 on a server device of a cloud service provider. The recommendation system 106 receives the event 10 or information from the event 10 from the device 102 via a network. The network may include one or multiple networks that use one or more communication platforms or technologies for transmitting data. For example, the network may include the Internet or other data link that enables transport of electronic data between respective devices of the environment 100. For example, the information for the event 10 may include the universal resource link (URL) for the webpage, content of the webpage, text of the search provided to a web browser, a product viewed using a web browser, a video playing on the webpage, and/or a song playing on the webpage.

The recommendation system 106 creates a query 11 based on the information for the event 10 and/or the user history 24. In some implementations, the query 11 is the event 10 performed by the user 104 (i.e., per-event retrieval). In some implementations, the query 11 is the user's 104 intents/interests/channels based on the event 10 and the user history 24 (e.g., an intent/interest/channel of the user 104 based on the webpages visited or queries performed by the user). For example, the user's 104 intents/interests/channels is inferred from multiple event interactions by the user 104.

The recommendation system 106 creates a generic embedding 12 for the query 11 that provides a representation of the query 11. An embedding is a mapping of sparse entities (events, users, etc.) into a dense vector in a geometric space. In other words, embeddings are encodings of objects (such as sentences, words, images, etc.) to points in a geometric space so objects that are nearby are more likely to be semantically similar. The items whose embeddings are close to the query embedding in the geometric space are typically recommended. The generic embedding 12 is an embedding of the query 11 that is the same for two users.

In some implementations, the generic embedding 12 is generated using a text embedding block that is able to output embeddings for events. In per-event retrieval, the query 11 is an event, so the text embedding block receives the query 11 as input and outputs the generic embedding 12. In some implementations, a textual description of the event 10 (e.g., text with the content from a webpage, a webpage title, text of a song, a transcript of dialog in a video, a caption of an image, and/or query text) is the input to the text embedding block and the generic embedding 12 is the output of the text embedding block. In some implementations, all events from user's 104 past history 24 is fed to the text embedding block and generic embedding for all events in past history 24 are obtained, which are used to obtain representation/embedding for the user's intent/interests/channels. The generic embedding 12 is a vector of real numbers that represents the query 11 in a point in the geometric space. In some implementations, the text embedding block is a machine learning model that processes the information for the query 11 and outputs the generic embedding 12 for the query 11.

The recommendation system 106 uses a user-specific morph operator 14 for the user 104 to generate a personalized embedding 16 for the query 11. The user-specific morph operators 14 are functions that take in a generic embedding 12 for the query 11 (or a non-personalized event embeddings) as an input and produce a personalized embedding 16 for the query 11. The user-specific morph operators 14 encode user preferences, which morph the generic embedding 12 toward an embedding that is personalized for a user. For example, if the user 104 is male and likes black color and the user 104 visits a t-shirt webpage, the generic embedding 12 represents a t-shirt, but the personalized embedding 16 represents men black t-shirts. The user-specific morph operator 14 receives the generic embedding 12 for the query 11 as input and outputs the personalized embedding 16 for the query 11 based on the user's 104 preferences. One example of a user-specific morph operator 14 includes matrix multiplication. Another example of a user-specific morph operator 14 includes machine learning models, such as, a neural network. Different user-specific morph operators 14 may be used for different users 104. For example, a first user has a matrix multiplication user-specific morph operator 14 and a second user has a neural network user-specific morph operator 14.

The recommendation system 106 identifies the user 104 and accesses, or otherwise obtains, the user-specific morph operator 14 from a morph operator creation component 112. The morph operator creation component 112 creates the user-specific morph operators 14 for each user 104 of the environment 100. In some implementations, the morph operator creation component 112 stores the user-specific morph operators 14 per user identification (ID) 22 so that the user-specific morph operators 14 may be used repeatedly without having to continuously compute the user-specific morph operators 14.

The morph operator creation component 112 creates the user-specific morph operators 14 for each user 104 based on the user history 24 received for each user 104 and/or the user profile information 26 (e.g., age, location, gender, etc.) for each user 104. The user history 24 is an aggregate of the past user activities using devices of the environment 100 (e.g., the device 102). In some implementations, the user history 24 is captured through past browsing behavior of the user 104 using browsers on the devices of the environment 100 (e.g., the device 102). Thus, each user activity (e.g., webpages visited, searches performed, products purchased, products viewed, products reviewed, songs listened to, and/or videos watched) that the user 104 performs using the browser is captured as part of the user history 24. The morph operator creation component 112 analyzes the user history 24 and/or user profile information 26 and learns the preferences of the user 104 and/or the habits of the user 104 based on the user activities performed by the user 104 and/or the profile information 26. The morph operator creation component 112 creates the user-specific morph operators 14 based on the analysis of the user history 24 and/or user profile information 26. As such, each user 104 has a different user-specific morph operator 14 that identify the learned preferences of the user 104 and/or the habits of the user 104.

In some implementations, the morph operator creation component 112 is a machine learning model that analyzes the user history 24 and outputs the user-specific morph operators 14. The machine learning model is trained to identify long-term preferences and/or habits of the user 104 based on the user activities. The machine learning model uses the information from the user activities to learn the long-term preferences or habits of the user 104.

In some implementations, the machine learning model uses standard contrastive loss in the training based on the user history 24. The machine learning model is trained to predict the next event of the user 104 based on the user history 24. To compute loss over the user 104, the item involved in a next event is taken as a ground truth positive. A set of queries are chosen from the user history 24 and a set of hard-negative items are identified and tuned as hyperparameters. The query(q) whose personalized embedding most closely resembled the clicked item (e.g., an advertisement or product) is chosen as a most promising query. The hard negative item most similar to the most promising seed event is also chosen. The training uses contrastive loss to bring the personalized embedding of the most promising query and the clicked item close to each other and moves away the personalized embedding of the most promising query and the chosen hard negative item. The loss is averaged over all training users and is used to train the machine learning model to output the user-specific morph operator 14 for each user 104.

The morph operator creation component 112 automatically learns the long-term user preferences for the user 104 and/or the user habits for the user 104 by analyzing the user history 24 and/or user profile information 26 and generates the user-specific morph operator 14 that identifies the learned user preferences or user habits for each user 104. The user-specific morph operators 14 transforms the generic embedding 12 for the query 11 to a personalized embedding 16 for the query 11. The personalized embedding 16 retains the information for the query 11 and incorporates the user's 104 long term preferences for the query 11.

In some implementations, the user-specific morph operator 14 is a machine learning model that receives the generic embedding 12 for the query 11 as input and outputs the personalized embedding 16 for the query 11 based on the learned user preferences or user habits. The user-specific morph operator 14 is a function that transforms the generic embedding 12 for the query 11 to a personalized embedding 16 for the query 11. For example, the function is a matrix. Another example of the function is a machine learning model, such as, a neural network. The personalized embedding 16 for the query 11 retains the information for the query 11 and incorporates the user's 104 long term preferences for the query 11. In some implementations, the user-specific morph operator 14 is a matrix multiplication operator that decomposes into multiple matrices. The user-specific morph operator 14 transforms the generic embedding 12 for the query 11 to a personalized embedding 16 for the query 11. The personalized embedding 16 represents the information for the query 11 and the user's 104 long term preferences for the query 11 in a multi-dimensional vector space.

As such, the user-specific morph operator 14 may be trained to support any format of the generic embedding 12 produced by any encoder or embedding production system, and thus, the morph operator creation component 112 and/or the user-specific morph operator 14 may be used with any recommendation system 106 to personalize the query 11. In some implementations, the user-specific morph operator 14 personalizes or transforms the generic embeddings 12 of the event 10 into a personalized embedding 16 for the event 10. In some implementations, the user-specific morph operator 14 is used to personalize or transform generic representations (e.g., generic embeddings 12) of user intents/interests/channels, or other user signals received by the recommendation system 106 into a personalized embedding 16 for the user intents/interests/channels, user signals, or other user representations.

The recommendation system 106 uses the personalized embedding 16 for the query 11 to access a datastore 108 of potential items 18 to provide in recommendations 20 in response to the event 10 occurring on the device 102. In some implementations, the datastore 108 includes a catalogue with millions of items 18. The recommendation system 106 uses the personalized embedding 16 to retrieve the items 18 from the datastore 108 that are related to the query 11 and also incorporate the user's 104 preferences or habits.

The recommendation system 106 provides recommendations 20 with the items 18 retrieved using the personalized embedding 16 for the user 104. The recommendations 20 with the items 18 may be presented on the display 110 of the device 102 in response to the event 10. In addition, the recommendations 20 with the items may be presented on multiple displays of a plurality of devices being used by the user 104. In some implementations, a ranking is applied to the items 18 and the items 18 are placed in an order based on the ranking. A subset of the items 18 (e.g., a top five ranked items) may be presented to the user 104 on the display 110. As such, the items 18 presented on the display 110 to the user 104 are selected based on the personalized embedding 16 for the user 104 and are tailored to the user's 104 preferences and/or habits. Thus, another user performing the same event 10 receives the recommendation 20 with the items 18 based on the other user's personalized embedding 16 and may receive different items than the user 104 since the recommendation system 106 treats each user 104 differently based on the preferences and/or habits of the user 104 identified by the user-specific morph operator 14 for each user 104.

In some implementations, one or more computing devices (e.g., servers and/or devices) are used to perform the processing of the environment 100. The one or more computing devices may include, but are not limited to, server devices, personal computers, a mobile device, such as, a mobile telephone, a smartphone, a PDA, a tablet, or a laptop, and/or a non-mobile device. The features and functionalities discussed herein in connection with the various systems may be implemented on one computing device or across multiple computing devices. For example, the morph operator creation component 112, the recommendation system 106, and the datastore 108 are implemented wholly on the same computing device. Another example includes one or more subcomponents of the morph operator creation component 112, the recommendation system 106, and/or the datastore 108 are implemented across multiple computing devices. Moreover, in some implementations, one or more subcomponent of the morph operator creation component 112, the recommendation system 106, and/or the datastore 108 may be implemented and are processed on different server devices of the same or different cloud computing networks.

In some implementations, each of the components of the environment 100 is in communication with each other using any suitable communication technologies. In addition, while the components of the environment 100 are shown to be separate, any of the components or subcomponents may be combined into fewer components, such as into a single component, or divided into more components as may serve a particular implementation. In some implementations, the components of the environment 100 include hardware, software, or both. For example, the components of the environment 100 may include one or more instructions stored on a computer-readable storage medium and executable by processors of one or more computing devices. When executed by the one or more processors, the computer-executable instructions of one or more computing devices can perform one or more methods described herein. In some implementations, the components of the environment 100 include hardware, such as a special purpose processing device to perform a certain function or group of functions. In some implementations, the components of the environment 100 include a combination of computer-executable instructions and hardware.

The environment 100 adapts to long-term preferences of the user 104 and takes into account immediate or short-term preferences of the user 104 to provide personalization in the retrieval of the items 18 presented to the user 104 in response to the event 10 performed by the user 104. In some implementations, the personalization in the retrieval of the items 18 is based on the event 10. In some implementations, the personalization in the retrieval of the items 18 is based on an interest/intent/channel of the user 104 inferred from the user history 24, the user profile information 26, and/or the event 10.

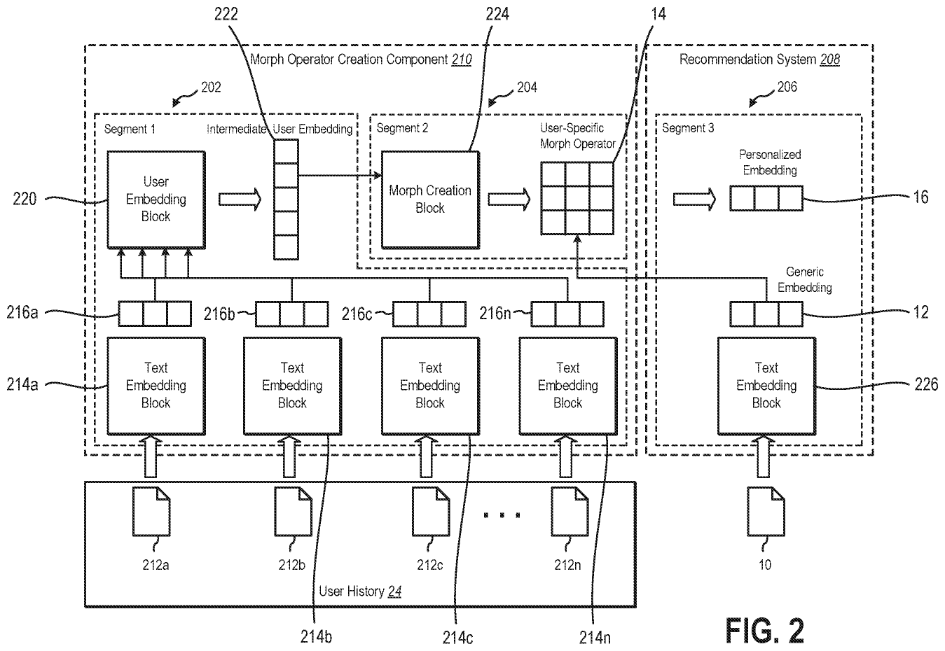

Referring now to FIG. 2, illustrated is an example morph operator creation component 210 and recommendation system 208 for use with different implementations of the present invention. For example, the morph operator creation component 210 is used instead of the morph operator creation component 112 in the environment 100 (FIG. 1) and the recommendation system 208 is used instead of the recommendation system 106 in the environment 100 for the personalized retrievals of items 18 (FIG. 1).

The morph operator creation component 210 is divided into a first segment 202 and a second segment 204. The first segment 202 receives the user history 24 with a plurality of user activities 212a, 212b, 212c up to 212n (where n is a positive integer). The user activities 212a, 212b, 212c up to 212n are provided to text embedding blocks 214a, 214b, 214c, 214n that convert the user activities 212a, 212b, 212c up to 212n into generic embeddings 216a, 216b, 216c up to 216n of the user activities 212a, 212b, 212c up to 212n. In some implementations, the text embedding blocks 214a, 214b, 214c, 214n are machine learning models. For example, the text embedding blocks 214a, 214b, 214c, 214n are a bidirectional encoder representation (BERT) trained in a Siamese fashion.

The generic embeddings 216a, 216b, 216c up to 216n are provided to a user embedding block 220 and converted into an intermediate user embedding 222. In some implementations, the user embedding block 220 is a machine learning model. For example, the user embedding block 220 is a multi-layer transformer model. The intermediate user embedding 222 is a generic compact representation of an aggregate of the user activities 212a, 212b, 212c up to 212n. For example, the intermediate user embedding 222 is a multi-dimensional vector representation for the user activities 212a, 212b, 212c up to 212n.

In some implementations, the processing of the first segment 202 occurs offline. As such, for each user 104 (FIG. 1) of the environment 100, the first segment 202 generates the intermediate user embedding 222 (the compact representation of the user activities 212a, 212b, 212c up to 212n and the user's profile information) from the user's 104 profile information and/or the user history 24 of the user 104. The intermediate user embeddings 222 are stored for each user 104.

The second segment 204 converts the intermediate user embeddings 222 into a user-specific morph operator 14. In some implementations, the second segment 204 converts the intermediate user embeddings 222 into the user-specific morph operator 14 in near real time in response to the user 104 performing the event 10.

In some implementations, the intermediate user embeddings 222 is a vector with D dimensions (where D is a positive integer) and the user-specific morph operator 14 is a matrix. The intermediate user embeddings 222 is passed through a single feed-forward layer with ReLU non-linearity and the D dimensional intermediate user embedding output is reshaped into a D×D matrix that serves as the user-specific morph operator 14 for the user 104. For example, D is equal to 64. By using the morph creation block 224 as a linear layer (matrix multiplication to transform the input features into output features using a weighted matrix), allows the conversion from the intermediate user embeddings 222 to the user-specific morph operator 14 to occur rapidly. The user-specific morph operator 14 encodes the user's 104 preferences into the matrices. As such, the second segment 204 converts the compact user embeddings (the intermediate user embeddings 222) from the first segment 202 to user-specific morph operators 14 in an inexpensive computational manner in near real time in response to the user 104 performing the event 10.

The recommendation system 208 includes a third segment 206 in communication with the second segment 204. The third segment 206 receives the event 10 and determines a query 11 from the event 10 and/or the user past history 24. The third segment 206 uses a text embedding block 226 to convert the query 11 into a generic embedding 12 for the query 11. In some implementations, the text embedding block 226 is a machine learning model.

In some implementations, the generic embedding 12 for the query 11 is a D dimensional vector and the user-specific morph operator 14 is represented by [D cross D] matrices, where D is the dimension of non-personalized embedding which capture the user's 104 interests and preferences. The third segment 206 uses the D cross D user-specific morph operator 14 matrix to morph the non-personalized generic embedding 12 for the query 11 towards the user's 104 preferences. By multiplying the D*D user-specific morph operator 14 with D dimensional generic embedding 12, to get the D dimensional personalized embedding 16. A residual connection is used for ease in optimization of the machine learning model and allowing machine learning training to commence with the non-personalized embedding. So, the personalized embedding=the generic embedding+the user-specific morph operator*the generic embedding.

The third segment 206 generates the generic embedding 12 for the query 11 in real time in response to the user 104 performing the event 10. The third segment 206 applies the user-specific morph operator 14 generated by the second segment 204 to the generic embedding 12 for the query 11 to generate the personalized embedding 16 for the query 11. The personalized embedding 16 for the query 11 retains the event information and incorporates the user's 104 long term preferences for the query 11.

In some implementations, a set of queries are selected and the personalized embeddings 16 are generated for the set of queries. In some implementations, the set of queries is selected from interests/intents/channels of the user 104 that are created from the user history 24 and/or the event 10. A set of items 18 are selected for the set of queries (q) based on the personalized embeddings 16. As such, the personal embeddings 16 may be for the set of queries (q) (e.g., the event 10, and/or interests/intents/channels of the user 104).

By splitting the morph operator creation component 210 into two separate segments (the first segment 202 and the second segment 204), personalized retrieval for the query 11 is provided in real time while maintaining low storage overheads and achieving high computational efficiency. By creating the intermediate user embeddings from all the user information (user profile and user events) using the morph operator creation component 210 (which may run offline) and storing the compact representation (the intermediate user embedding 222 that takes less memory as compared to storing the user-specific morph operators 14), the user-specific morph operators 14 may be computed from the intermediate user embedding 222 in real-time.

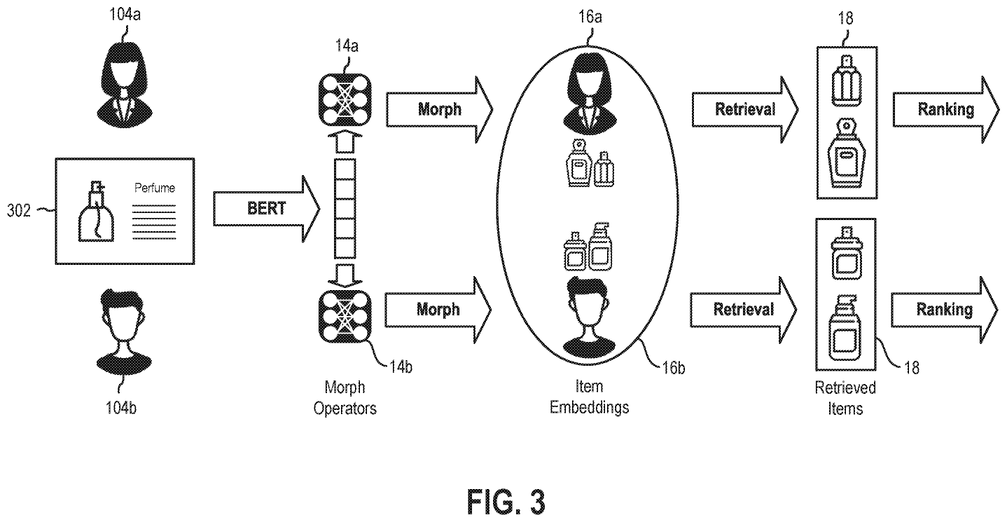

Referring now to FIG. 3, illustrated is an example of personal retrieval performed by the recommendation system 106 (FIG. 1) for an event 10 (FIG. 1) of accessing a perfume webpage 302. Two users 104 (a female user 104a and a male user 104b) access the same perfume webpage 302.

A user-specific morph operator 14a is accessed by the recommendation system 106 for the female user 104a that includes the female user's 104a long term preferences for perfumes based on previous user activities performed by the female user 104a. For example, the long-term preferences of the female user 104a indicate that the female user 104a previously purchased a floral perfume and a citrus plant. The recommendation system 106 uses the user-specific morph operator 14a for the female user 104a to generate a personalized embedding 16a with the female user's 104a preferences for perfumes (citrus and floral). The recommendation system 106 retrieves items 18 to present to the female user 104a based on the personalized embedding 16a for the female user 104b. For example, the recommendation system 106 retries a floral woman's perfume and a citrus woman's perfume to present as recommendations on the perfume webpage 302. As such, the female user 104a receives perfumes tailored to the female user's 104a preferences as recommendations presented on the perfume webpage 302 in response to the female user 104a accessing the perfume webpage 302.

The recommendation system 106 accesses the user-specific morph operator 14b for the male user 104b that includes the male user's 104b long term preferences for perfumes based on previous user activities performed by the male user 104b. For example, the long-term preferences of the male user 104b indicate that the male user 104b likes woody fragrances and spicy fragrances. The recommendation system 106 uses the user-specific morph operator 14b for the male user 104b to generate a personalized embedding 16b with the male user's 104b preferences for perfumes (woody and spicy).

The recommendation system 106 retrieves items 18 to present to the male user 104b based on the personalized embedding 16b for the male user 104b. For example, the recommendation system 106 retries a woody male perfume and a spicy male perfume to present as product recommendations on the perfume webpage 302. As such, the male user 104b receives perfumes tailored to the male user's 104b preferences as product recommendations in response to the male user 104b accessing the perfume webpage 302. The perfumes recommended to the male user 104b are different from the perfumes recommended to the female user 104a since the personal preference for perfumes of the male user 104b and the female user 104a are different.

In some implementations, the recommendation system 106 performs a ranking on the retrieved items 18 to determine which items 18 to show to the users 104 (e.g., the female user 104a and the male user 104b). The ranking occurs on the items 18 that are retrieved based on the personalized item embeddings for the users 104 (e.g., the female user 104a and the male user 104b). The items 18 may be nearest items to the personalized item embeddings, which may be obtained using an Approximate Nearest Neighbor Structure (ANN).

As such, even though the female user 104a and the male user 104b performed the same event 10 (accessing the same perfume webpage 302), the female user 104a and the male user 104b received distinct items 18 as recommendations in response to accessing the perfume webpage 302 based on the personal preferences or habits of the female user 104a and the male user 104b.

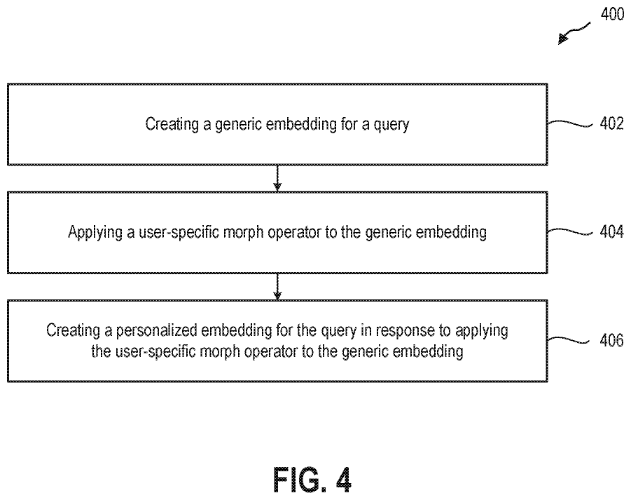

Referring now to FIG. 4, illustrated is an example method 400 for personalized retrievals. The actions of the method 400 are discussed below with reference to the architecture of FIGS. 1 and 2.

At 402, the method 400 includes creating a generic embedding for a query. The recommendation system 106 creates a generic embedding 12 for a query 11. In some implementations, the query 11 is the event 10 performed by the user 104. In some implementations, the query 11 is any user representation. In some implementations, the query 11 is an interest/intent/channel of the user 104. For example, the interest of the user 104 is created from the event 10 and/or the user past history 24 performed by the user 104. Another example includes the interest of the user 104 is inferred from multiple event interactions by the user 104.

In some implementations, the recommendation system 106 creates the generic embedding 12 for the query 11 in response to the user 104 performing the event 10. For example, the recommendation system 106 creates the generic embedding 12 for a webpage in response to the user 104 visiting the webpage. In some implementations, the generic embedding 12 encodes or embeds the query 11 using a textual description of the event 10. For example, the generic embedding 12 encodes or embeds the query 11 using a webpage title or the text of a query provided using a browser.

At 404, the method 400 includes applying a user-specific morph operator to the generic embedding. The user-specific morph operator 14 identifies the user preferences and/or habits for the user 104. The user-specific morph operator 14 is automatically learned using a user history 24 of previous actions performed by the user 104 or using user profile information 26. The recommendation system 106 applies the user-specific morph operator 14 to the generic embedding 12 of the query 11.

At 406, the method 400 includes creating a personalized embedding for the query by applying the user-specific morph operator to the generic embedding. The recommendation system 106 creates a personalized embedding 16 for the query 11 by applying the user-specific morph operator 14 to the generic embedding 12 for the query 11. The user-specific morph operators 14 transforms the generic embedding 12 for the query 11 to a personalized embedding 16 for the query 11. The personalized embedding 16 for the query 11 retains information for the query 11 and incorporates the user preferences for the query 11. The personalized embedding 16 contains the query 11 information (or the user's 104 short term intent information) and also the long-term preferences learned from the user's 104 past activities (user profile information 26 or the user history 24). As such, the personalized embedding 16 provides personalization using the user-specific morph operators 14 for the query 11 (e.g., the events 10 performed by the user 104, and/or interest/intents/channels of the user 104). Moreover, creating the personalized embedding 16 for the query 11 provides two-sided personalization while only incurring the cost of one-sided personalization for few specific choices of morph operators.

In some implementations, the recommendation system 106 uses the personalized embeddings 16 for the query 11 to retrieve items 18 to provide in a recommendation 20 for presentation in response to the event 10 occurring using the device 102. The items 18 recommended are similar to the query 11 and incorporate the preferences of the user 104. The recommendation system 106 uses the personalized embedding 16 for the query 11 to access a datastore 108 of potential items 18 to provide in a recommendation 20 in response to the event 10. In some implementations, the datastore 108 includes a catalogue with millions of items 18 that can be recommended to the users 104. The recommendation system 106 uses the personalized embedding 16 to retrieve the items 18 from the datastore 108 that are related to the query 11 and also incorporate the user's 104 preferences or habits. The items 18 are selected based on the user preferences for the user 104 identified in the user-specific morph operator 14. For example, the items 18 are presented on a display 110 of a device 102 of the user 104 in response to the event 10 occurring using the device 102.

In some implementations, the recommendation system 106 outputs the personalized embedding 16 for the query 11 for use by other applications or downstream tasks for personalization of the query 11.

The user-specific morph operator 14 may be trained to support any format of the generic embedding 12 provided by the recommendation system 106, and thus, the user-specific morph operator 14 may be used with any recommendation system 106 to personalize or transform generic representations (e.g., generic embeddings 12) of the query 11 (e.g., the events 10, the user intents/interests/channels) received by the recommendation system 106 into a personalized embedding 16 for the query 11.

The method 400 provides personalized embeddings 16 for the query 11 to use with retrieval of items 18 in response to the event 10. As such, the method 400 is used to provide personalized retrieval of items 18 to tailor the retrieved items 18 to the user's 104 long-term preferences.

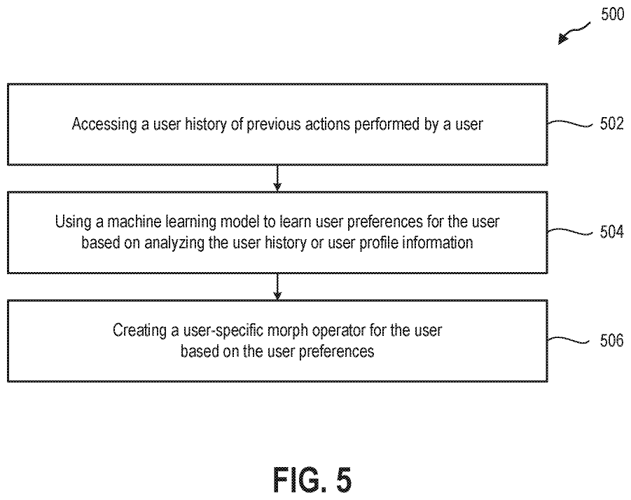

Referring now to FIG. 5, illustrated is an example method 500 for creating a user-specific morph operator. The actions of the method 500 are discussed below with reference to the architecture of FIGS. 1 and 2.

At 502, the method 500 includes accessing a user history of previous actions performed by a user and/or the user profile information. The morph operator creation component 112 accesses, or otherwise obtains, the user history 24 of previous actions performed by the user 104.

At 504, the method 500 includes using a machine learning model to learn user preferences for the user based on analyzing the user history and/or user profile information. In some implementations, the morph operator creation component 112 is a machine learning model that learns the user preferences for the user 104 based on analyzing the user history 24 and/or the user profile information 26. The machine learning model learns to capture the user's 104 long term interests and/or preferences in order to increase a likelihood of the user 104 clicking on the recommended items 18 that are retrieved based on these long-term interests.

At 506, the method 500 includes creating a user-specific morph operator for the user based on the user preferences. The morph operator creation component 112 creates a user-specific morph operator 14 for the user 104 based on the user preferences. The user-specific morph operator 14 identifies the user preferences learned for the user 104. In some implementations, the user-specific morph operator 14 is a separate machine learning model that receives the generic embedding 12 for the event 10 as input and outputs the personalized embedding 16 for the event 10 based on the learned user preferences or user habits.

In some implementations, the user-specific morph operator 14 is a function based on the user history of previous actions performed by the user. The function transforms the generic embedding 12 for a query 11 (e.g., an event 10 performed by the user 104, and/or an interest/intent/channel of the user 104) to a personalized embedding 16 for the query 11. The personalized embedding 16 for the query 11 retains the information for the query 11 and incorporates the user's 104 long term preferences for the query 11.

In some implementations, the user-specific morph operator 14 is a matrix multiplication operator that decomposes into multiple matrices. The user-specific morph operator 14 transforms the generic embedding 12 for the event 10 to a personalized embedding 16 for the event 10. The personalized embedding 16 represents the query 11 information and the user's 104 long term preferences for the event 10 in a multi-dimensional vector space.

In some implementations, the morph operator creation component 112 creates an intermediate user embedding of the user history 24 or the user profile information 26 that is an aggregate of the previous actions performed by the user 104 and/or the user profile information 26. The morph operator creation component 112 uses the intermediate user embedding to create the user-specific morph operator 14.

In some implementations, the morph operator creation component 112 generates the intermediate user embedding 222 offline and stores the intermediate user embedding for the user 104. In some implementations, the morph operator creation component 112 generates the intermediate user embedding 222 using a different machine learning model. The morph operator creation component 112 uses the intermediate user embedding to generate the user-specific morph operator 14 in real time in response an event 10 occurring by the user 104.

As such, the method 500 is used to create user-specific morph operators 14 that are used to transform a generic embedding 12 for a query 11 to a personalized embedding 16 that retains the query 11 information and incorporates the user's long-term preferences for the query 11.

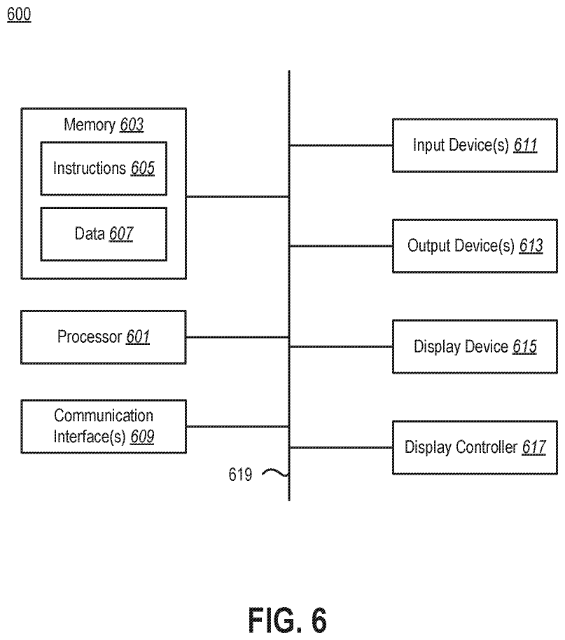

FIG. 6 illustrates components that may be included within a computer system 600. One or more computer systems 600 may be used to implement the various methods, devices, components, and/or systems described herein.

The computer system 600 includes a processor 601. The processor 601 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 601 may be referred to as a central processing unit (CPU). The processor 61 may be referred to as a Graphics Processing Unit (GPU). Although just a single processor 601 is shown in the computer system 600 of FIG. 6, in an alternative configuration, a combination of processors (e.g., an ARM and DSP) could be used.

The computer system 600 also includes memory 603 in electronic communication with the processor 601. The memory 603 may be any electronic component capable of storing electronic information. For example, the memory 603 may be embodied as random access memory (RAM), read-only memory (ROM), magnetic disk storage mediums, optical storage mediums, flash memory devices in RAM, on-board memory included with the processor, erasable programmable read-only memory (EPROM), electrically erasable programmable read-only memory (EEPROM) memory, registers, and so forth, including combinations thereof.

Instructions 605 and data 607 may be stored in the memory 603. The instructions 605 may be executable by the processor 601 to implement some or all of the functionality disclosed herein. Executing the instructions 605 may involve the use of the data 607 that is stored in the memory 603. Any of the various examples of modules and components described herein may be implemented, partially or wholly, as instructions 605 stored in memory 603 and executed by the processor 601. Any of the various examples of data described herein may be among the data 607 that is stored in memory 603 and used during execution of the instructions 605 by the processor 601.

A computer system 600 may also include one or more communication interfaces 609 for communicating with other electronic devices. The communication interface(s) 609 may be based on wired communication technology, wireless communication technology, or both. Some examples of communication interfaces 609 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 600 may also include one or more input devices 611 and one or more output devices 613. Some examples of input devices 611 include a keyboard, mouse, microphone, remote control device, button, joystick, trackball, touchpad, and lightpen. Some examples of output devices 613 include a speaker and a printer. One specific type of output device that is typically included in a computer system 600 is a display device 615. Display devices 615 used with embodiments disclosed herein may utilize any suitable image projection technology, such as liquid crystal display (LCD), light-emitting diode (LED), gas plasma, electroluminescence, or the like. A display controller 617 may also be provided, for converting data 607 stored in the memory 603 into text, graphics, and/or moving images (as appropriate) shown on the display device 615.

The various components of the computer system 600 may be coupled together by one or more buses, which may include a power bus, a control signal bus, a status signal bus, a data bus, etc. For the sake of clarity, the various buses are illustrated in FIG. 6 as a bus system 619.

In some implementations, the various components of the computer system 600 are implemented as one device. For example, the various components of the computer system 600 are implemented in a mobile phone or tablet. Another example includes the various components of the computer system 600 implemented in a personal computer.

As illustrated in the foregoing discussion, the present disclosure utilizes a variety of terms to describe features and advantages of the model evaluation system. Additional detail is now provided regarding the meaning of such terms. For example, as used herein, a “machine learning model” refers to a computer algorithm or model (e.g., a classification model, a clustering model, a regression model, a language model, an object detection model) that can be tuned (e.g., trained) based on training input to approximate unknown functions. For example, a machine learning model may refer to a neural network (e.g., a convolutional neural network (CNN), deep neural network (DNN), recurrent neural network (RNN)), or other machine learning algorithm or architecture that learns and approximates complex functions and generates outputs based on a plurality of inputs provided to the machine learning model. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Computer-readable mediums may be any available media that can be accessed by a general purpose or special purpose computer system. Computer-readable mediums that store computer-executable instructions are non-transitory computer-readable storage media (devices). Computer-readable mediums that carry computer-executable instructions are transmission media. Thus, by way of example, and not limitation, implementations of the disclosure can comprise at least two distinctly different kinds of computer-readable mediums: non-transitory computer-readable storage media (devices) and transmission media.

As used herein, non-transitory computer-readable storage mediums (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, a datastore, or another data structure), ascertaining and the like. Also, “determining” can include receiving (e.g., receiving information), accessing (e.g., accessing data in a memory) and the like. Also, “determining” can include resolving, selecting, choosing, establishing, predicting, inferring, and the like.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the implementations that falls within the meaning and scope of the claims is to be embraced by the claims.

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

1. A method, comprising:
creating a generic embedding for a query;
applying a user-specific morph operator to the generic embedding, wherein the user-specific morph operator identifies user preferences for a user;
using the user-specific morph operator to transform the generic embedding for the query to a personalized embedding for the query; and
using the personalized embedding for the query to provide a recommendation with one or more items to present for the query that are related to the query and incorporate preferences of the user.

2. The method of claim 1, wherein the query is an event performed by the user.

3. The method of claim 1, wherein the query is an interest of the user.

4. The method of claim 3, wherein the interest of the user is inferred from multiple event interactions by the user.

5. The method of claim 1, wherein the query is any user representation.

6. The method of claim 1, wherein the personalized embedding for the query retains information for the query and incorporates the user preferences for the query.

7. The method of claim 1, wherein creating the generic embedding for the query is in response to the user performing an event.

8. The method of claim 1, wherein the generic embedding represents the query by encoding a textual description of the query using a machine learning model.

9. The method of claim 1, wherein the user-specific morph operator is automatically learned using a user history of previous actions performed by the user or using user profile information.

10. The method of claim 1, wherein applying the user-specific morph operator to the generic embedding further comprises:
incorporating the user preferences into information for the query.

11. (canceled)

12. The method of claim 1, wherein the one or more items are selected based on the user preferences for the user.

13. The method of claim 1, wherein creating the personalized embedding for the query provides two-sided personalization on the query and item side while incurring a cost of one-sided personalization.

14. A method, comprising:
accessing a user history of previous actions performed by a user;
using a machine learning model to learn user preferences for the user based on analyzing the user history or user profile information;
creating a user-specific morph operator for the user based on the user preferences;
identifying an event performed by the user; and
using the user-specific morph operator to generate a personalized embedding for the event.

15. The method of claim 14, wherein the user-specific morph operator identifies the user preferences learned for the user.

16. The method of claim 14, wherein the user-specific morph operator is a separate machine learning model or a matrix.

17. The method of claim 14, wherein the user-specific morph operator is a function based on the user history of previous actions performed by the user or user profile information.

18. The method of claim 14, further comprising:
creating an intermediate user embedding of the user history or the user profile information, wherein the intermediate user embedding is an aggregate of the previous actions performed by the user.

19. The method of claim 18, wherein the intermediate user embedding is used to create the user-specific morph operator.

20. The method of claim 18, wherein the intermediate user embedding is generated offline using a different machine learning model and stored for the user, and
wherein the intermediate user embedding is used to create the user-specific morph operator in real time.
